(19) United States
(12) Patent Application Publication
(10) Pub. No.: US 2014/0048961 A1
(43) Pub. Date: Feb. 20, 2014

(54) DIFFUSOR AND DIFFUSOR UNIT FOR DIFFUSING A GAS INTO A LIQUID

(71) Applicants: Johan Tegle, Osterskar (SE); Stefan Nordemo, Stockholm (SE); Per Porath, Bromma (SE)

(72) Inventors: Johan Tegle, Osterskar (SE); Stefan Nordemo, Stockholm (SE); Per Porath, Bromma (SE)

(73) Assignee: XYLEM IP HOLDINGS LLC, White Plains, NY (US)

(21) Appl. No.: 14/113,835

(22) PCT Filed: Apr. 23, 2012
(86) PCT No.: PCT/SE2012/050423

§ 371 Date: Oct. 25, 2013

(30) Foreign Application Priority Data
Apr. 26, 2011 (SE) 1150358-8

(51) Int. Cl. B01F 3/04

(52) U.S. Cl. CPC B01F 3/04241
USPC 261/100

(57) ABSTRACT

A diffusor for diffusing a gas into a liquid including a membrane, a supporting structure supporting the membrane and a holder arranged to connect the supporting structure to a gas supply conduit, at least a part of the membrane being perforated. The membrane defines an inner chamber, and at least a part of the supporting structure is arranged in the inner chamber of the membrane, the supporting structure including at least one channel extending from an inlet opening that is in, direct or indirect, fluid communication with the gas supply conduit to an outlet opening that is in fluid communication with the inner chamber of the membrane.

### TECHNICAL FIELD OF THE INVENTION

The present invention relates in general to a diffusor, also known under the name aerator/distributor, which is intended for diffusing a gas into a liquid. Especially the present invention relates to a diffusor for diffusing air into waste water, in order to oxygenate the waste water.

The invention relates to a diffusor comprising a membrane, a supporting structure supporting said membrane and a holder arranged to connect said supporting structure to a gas supply conduit, at least a part of the membrane being perforated. The invention also relates to a diffusor unit comprising a membrane and a supporting structure.

### BACKGROUND OF THE INVENTION AND PRIOR ART

Within the technical field of treating waste water, so-called diffusors or aerators have since long been used in the process step of aerating/oxygenating liquid/waste water.

Diffusors are arranged to diffuse compressed air into waste water, in order to oxygenate. Thus, the use of diffusors takes place firstly at treatment stations, during the biologic treatment step, in which the preferably are arranged to cover an as large part of the bottom of the basin as possible. To the basin is fed waste water that is full of nutrition, as well as microorganism that need oxygen to be able to use and degrade the nutrition that is present in the waste water. The diffusers are arranged to release small bubbles of air into the waste water, which bubbles oxygenate the liquid at the same time as they cause a stirring of the waste water in order to obtain a homogenized liquid mixture. The process of adding air/oxygen to the waste water is costly, since you basically whish to achieve as small bubbles of air as possible in order to increase the oxygen transfer efficiency, however this is diametrically opposed to the fact that the pressure resistance of the diffusers increase concurrently with the decrease of the size of the air bubbles.

Diffusers and their membranes are worn by time and runs the risk of at least partly be clogged, which entail that the oxygen transfer per monetary unit decreases and the pressure in the diffusers increases, and thereby the diffusers and/or the membranes must be periodically exchanged.

A known type of diffusers having exchangeable membranes comprises a supporting structure in the shape of a cone having a lid. The cone is connected to the gas supply conduit and the lid presents a centrally located hole through which the inner space of the delimited by the cone and the lid is in fluid communication with the area above the lid. Thereto a membrane is arranged above the lid and is gripped along its peripheral edge by means of a lock collar. During an exchange of the membrane the lock collar and the old membrane shall be removed and then the new membrane shall be placed correctly. During remounting of the lock collar the risk of crumple/displace the new membrane from its contemplated/optimal position is large, and thereby leaks may arise. Thus it is very time consuming for the operator to exchange the about hundreds of membranes per basin.

Another known type of diffusers have the shape of an oblong panel in which the supporting structure besides supporting the membrane of the diffusor also constitute the gas supply conduit. This type of diffusor require special tools in order to be able to exchange the membrane, and thereto it is a great risk that the new membrane does not allow oneself to be mounted in a serviceable manner in or in connection with the basin, but the exchange must be performed in a specially equipped repair shop. Thus, as a rule the entire old diffusor is exchanged by a new diffusor even if only the membrane is worn out. These facts entail negative environmental influences as well as high manufacturing and handling costs.

Another know type of diffusor has the shape of a large piece of a stainless metal plate onto which a perforated membrane is placed, the membrane being locked to the metal plate at a circumferential peripheral edge. The membrane presents also a connection, at which a gas supply conduit is connected in order to guide pressurized gas into the space that is delimited by the membrane and the metal plate. This diffusor is expensive per square meter covered bottom area, at the same time as the membrane is not exchangeable which entail negative environmental influences and expensive handling costs.

Thereto known diffusers present relatively low bottom coverage, i.e. how much of the bottom of the basin that is covered by the air bubble generating membrane, as well as high cost per square meter covered bottom area.

### OBJECT OF THE INVENTION

The present invention aims at obviating above mentioned drawbacks and failings of previously known diffusors and at providing an improved diffusor and diffusor unit. A basic object of the invention is to provide an improved diffusor of initially described type, which admit easy and environmental friendly exchange of a diffusor membrane.

Another basic object of the invention is to provide a diffusor unit, which is easy to exchange without any need of special tools.

Another object of the invention is to provide a diffusor being flexible to orientate in order to obtain great bottom coverage.

It is another object of the invention to provide a diffusor that admit flexible design of the individual membrane and the adherent supporting structure with the intention to be adapted to the shape of adjacent installations and the specific basin.

### BRIEF DESCRIPTION OF THE INVENTION

According to the invention at least the basic object is attained by means of the initially defined diffusor, which is characterized in that the membrane define an inner chamber, and at least a part of the supporting structure is arranged in the inner chamber of the membrane, the supporting structure comprising at least one channel extending from an inlet opening that is in, direct or indirect, fluid communication with the gas supply conduit to an outlet opening that is in fluid communication with said inner chamber of said membrane, the supporting structure comprising a plate, which is arranged in the inner chamber of the membrane and which comprises a trough hole, and an attachment means, which is arranged in said through hole and which is connected to the holder.

Thus the present invention is based on the insight that the active area of the diffusor can be maximized when the supporting structure is arranged inside the membrane.

Preferred embodiments of the present invention are further defined by the dependent claims.

Preferably the membrane of the diffusor comprises a first membrane member and a second membrane member, which are connected to each other near to a circumferential peripheral edge, preferably by means of welding or vulcanization. This entail easy manufacturing and handling of the membrane unit, which comprises the membrane and the supporting structure that at least partly is enclosed by the membrane.

According to yet another preferred embodiment at least a part of the first membrane member perforated, at the same time as second membrane member is either imperforated or comprises a number of drainage holes. This lead to the air bubbles leaving the diffusor in a controllable manner via the first membrane member, which is preferred when the first membrane member is turned upwards.

Preferably at least a part of the flexible membrane is reinforced, preferably by means of metal wire, synthetic fibre or glass fibre, in order to prevent the membrane from stretching when the diffusor is active and the membrane is inflated.

In a preferred embodiment the supporting structure comprises a plate, which is arranged in the inner chamber of the membrane, and an attachment means, which is arranged to secure the plate and the membrane to the holder. It is still more preferred that the outlet opening of the supporting structure mouth in a first surface of the plate, and that the first surface of the plate is turned towards the first membrane member of the membrane.

Thereto it is preferred that the plate of the supporting structure comprises a through hole, which is arranged in a centre region of the plate of the supporting structure. In a still more preferred embodiment the through hole of the plate overlap a through hole arranged in the first membrane member and a trough hole arranged in the second membrane member, and thereto the attachment means of the supporting structure comprises a head and a stem, wherein the head of the attachment means cover the through hole of the first membrane member and clamp the first membrane member against the first surface of the plate, and wherein the stem of the attachment means is connected to said head and to the holder, the second membrane member being clamped between a second surface of the plate, which second surface is opposite the first surface of the plate, and a seat in the holder. This entail that the entire membrane unit easily and quickly may be connected to the holder by means of an attachment means.

It is still more preferred that the stem of the attachment means comprises a first channel branch of the channel of the supporting structure. In this way it is secured that the gas will reach the inner chamber of the membrane without the need for expensive and complicated additional equipment.

Preferably the plate of the supporting structure is turnable in relation to the seat of the holder, which entail that the orientation of the every single membrane unit may be adapted to adjacent installations and thereby the bottom coverage may be maximized.

The object of the invention is also attained by means of the initially defined diffusor unit, which is characterized in that the membrane comprises an inner chamber, and at least a part of the supporting structure is arranged in the inner chamber of the membrane, the supporting structure comprising at least one channel extending from an inlet opening that is arranged to be in, direct or indirect, fluid communication with the gas supply conduit to an outlet opening that is in fluid communication with said inner chamber of said membrane.

Further advantages and features of the invention will be apparent from the other dependent claims as well as from the following detailed description of preferred embodiments.

### BRIEF DESCRIPTION OF THE DRAWINGS

A more complete understanding of above mentioned and other features and advantages of the present invention will be apparent from the follow detailed description of preferred embodiments with reference to the accompanying drawings, in which:

FIG. 1 is a schematic perspective view from above of an inventive diffusor, a piece of the membrane being removed,

FIG. 2 is a schematic radially cut away view of a part of the inventive diffusor according to a first embodiment,

FIG. 3 is a schematic radially cut away view of a part of the inventive diffusor according to a second embodiment,

FIG. 4 is a schematic radially cut away view of a part of the inventive diffusor according to a third embodiment,

FIG. 5 is a schematic radially cut away view of a part of the inventive diffusor according to a fourth embodiment,

FIG. 6 is a schematic radially cut away view of a part of the inventive diffusor according to a fifth embodiment, and

FIG. 7 is a schematic radially cut away view of the inventive diffusor according to FIG. 6.

### DETAILED DESCRIPTION OF PREFERRED EMBODIMENTS

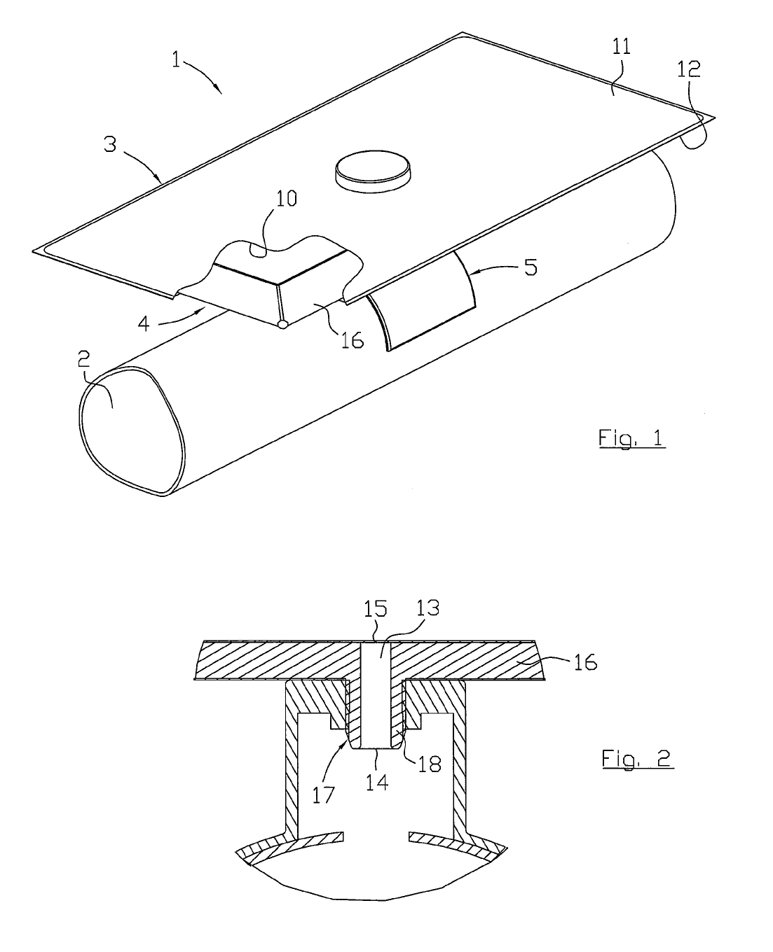

In FIG. 1 is disclosed an inventive diffusor, generally designated 1, which is arranged to diffuse gas into a liquid, especially air into waste water in order to oxygenize the waste water. The diffusor 1 is applied to a gas supply conduit 2, that is connected to a compressed air source and that is arranged to guide pressurized air/gas to said diffusor 1. It shall be pointed out that the gas supply conduit 2, also known as piping, may comprise a number of branches each supporting a number of diffusors 1, in order to cover an as large part as possible of the bottom of a basin (not shown). The gas supply conduit 2 may be placed directly against the bottom of the basin or be provided with any suitable stand.

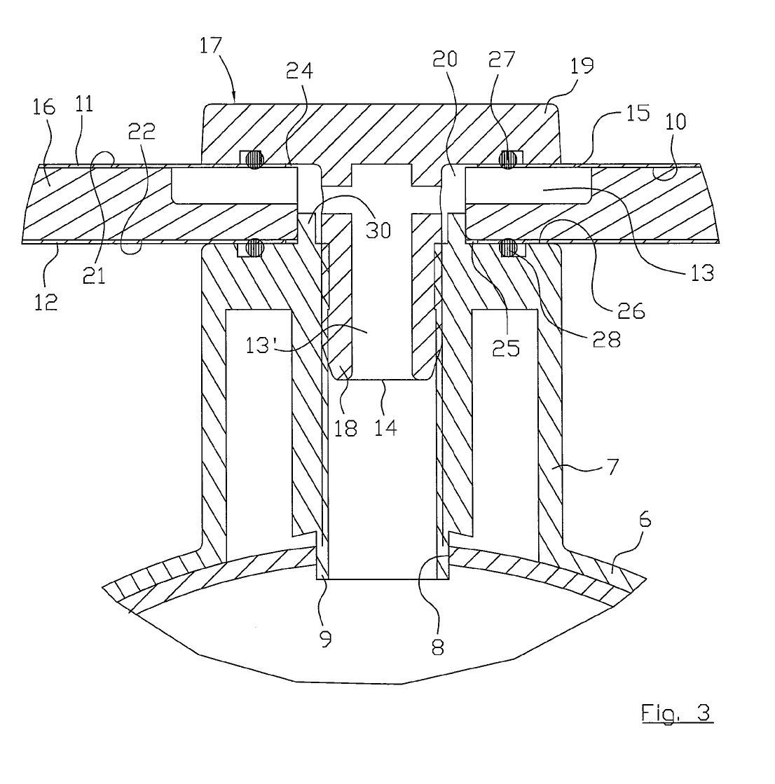

Reference is now also made to FIG. 2 that disclose a part of the first embodiment of the inventive diffusor 1, and to FIG. 3 that disclose a part of a second embodiment of the inventive diffusor 1. The inventive diffusor comprises a membrane, generally designated 3, a supporting structure, generally designated 4, supporting said membrane 3 and at least one holder, generally designated 5. The inventive diffusor unit comprises said membrane 3 and said supporting structure 4, said diffusor unit being the part of the diffusor that is regarded as a so called wearing part and may thereby be exchanged at service. The holder 5 is arranged to connect the supporting structure 4, and thereby the diffusor unit, to the gas supply conduit 2.

The holder 5 is in the shown embodiment fixedly connected to the gas supply conduit 2, however, the holder 5 may be disengageably connectable to the gas supply conduit 2 without deviating from the basic inventive idée.

The holder 5 comprises in the preferred embodiment a pipe engagement part 6 that is connected to the gas supply conduit 2 by means of adhesive, welding, vulcanization, etc. or by means of a disengageable clamp connection, etc. (not shown), and a spacer part 7 that projects from the pipe engagement part 6 in the direction from the gas supply conduit 2. Upon connection of the holder 5 to the gas supply conduit 2 a suitable hole 8 is first generated in the upper part of the gas supply conduit 2 whereupon the holder 5 is applied over said hole 8. Thus, in the mounted state the spacer part 7 of the holder 5 is in fluid communication with the gas supply conduit 2 via said hole 8. Preferably the holder 5 presents a projecting trunnion 9 that is inserted into said hole 8 for correct positioning of the holder 5 in relation to the gas supply conduit 2. Preferably the spacer part 7 of the holder shall extend vertically upwards from the gas supply conduit 2. It shall be pointed out that a great number of sealed holders 5 may be applied onto the gas supply conduit 2 whereupon only the holders that at the moment are about to be connected to a supporting structure is opened, thus several diffuser units, i.e. supporting structure and membrane, may easily be added to the system at a later point.

The holder 5 may according to an alternative, not shown, embodiment be constituted by an upside-down T-piece, to which an incoming gas supply conduit and outgoing gas supply conduit are connected, wherein a diffusor unit may be connected in angle to said two gas supply conduits. It shall be pointed out that an outgoing gas supply conduit not necessarily need to be connected to said T-piece, which instead may be sealed and thereby form an end to this branch of the gas supply conduit 2. It shall be pointed out that several such T-pieces may be connected to each other, whereupon some T-pieces thereby is indirectly connected to the gas supply conduit 2.

According to the invention the membrane 3 define an inner chamber 10, wherein at least a part of the supporting structure 4 is arranged in said inner chamber 10. Thereto the membrane 3 is at least partly perforated, which perforations are arranged to allow dispersion of gas bubbles from said inner chamber 10 to the surrounding liquid. Preferably the membrane 3 comprises a first membrane member 11 and a second membrane member 12, which are connected to each other at the area of a circumferential peripheral edge. In the preferred embodiment shown in FIG. 1 the first membrane member 11 is turned upwards and the second membrane member 12 is turned downwards. Said first membrane member 11 and said second membrane member 12 are in a preferred embodiment constituted by two separate membrane members that are connected by means of welding, vulcanization, etc. along the entire circumferential peripheral edge. Upon welding two parallel welds may be used as a safety measure. According to alternative embodiments the membrane may for instance be constituted by a tube piece that is closed in two opposed ends, or by a double folded membrane piece that is closed along the part of the circumferential peripheral edge that is not constituted by the fold. In yet another preferred embodiment at least a part of the circumferential peripheral edge is openable/recloseable in order to provide access to the inner chamber 10 of the membrane 3 such that the membrane 3 or the supporting structure 4 may be exchanged in the diffusor unit. The first membrane member 11 is at least partly perforated, preferably the entire first membrane member 11 is perforated, however the part of first membrane member 11 that is perforated shall be strictly greater than 0% and less than or equal to 100%. The second membrane member 12 may either be imperforated, at least partly perforated and/or comprise a number of drainage holes for draining liquid that has leaked into the inner chamber 10 of the membrane 3.

The membrane 3 is preferably made of an elastomer, such as polyurethane-rubber, EPDM-rubber or the like, or of a plastic, such as thermoplastic polypropylene, polyamide, polythene or the like. It shall be pointed out that the first membrane member 11 and the second membrane member 12 may be made of different material and/or have different thickness. Thereto it is preferred that at least a part of the membrane 3 is reinforced, preferably by means of metal wire, synthetic fibre or glass fibre, such that the membrane 3 is not stretched when the diffusor 1 is activated.

The supporting structure 4 comprises at least one channel 13 extending from an inlet opening 14 that in the shown embodiments is in indirect fluid communication with the gas supply conduit 2 via the holder 5, more precisely via the spacer part 7 of the holder, to an outlet opening 15 that is in fluid communication with the inner chamber 10 of the membrane 3. It shall be pointed out that the channel 13 of the supporting structure also may be in direct fluid communication with the gas supply conduit 2 without deviating from the basic inventive idée. Preferably the supporting structure 4 comprises a plate 16 arranged in the inner chamber 10 of the membrane 3, and a attachment means, generally designated 17, arranged to secure the plate 16 and the membrane 3 to the holder 5.

In the embodiment according to FIG. 2 the attachment means 17 is constituted by an externally threaded stem 18 that projects from and is connected to the plate 16, and in the embodiment according to FIG. 3 the attachment means 17 is constituted by a separate element comprising a head 19 and an externally threaded stem 18, wherein the stem 18 project from and is fixedly connected to the head 19 and thereto extend through a through hole 20 in the plate 16, which through hole 20 preferably is arranged in a centre area of the plate 16. It shall be pointed out that the plate 16, in that case the diffusor unit is relatively large, may present two or more through holes 20, whereupon an attachment means 17 extend through each hole 20 and is connected to a respective holder 5, in order to provide greater stability to the system and/or in order to distribute the compressed air more uniformly to the inner chamber 10 of the membrane.

It shall be pointed out that the attachment means in an alternative, not shown, embodiment may be constituted by an internally threaded hole in the plate 16 and an externally threaded pin projecting from the holder 15, or that the attachment means in yet another alternative, not shown, embodiment may be constituted by a cap having an internally threaded hole and an externally threaded pin projecting from the holder 15, which pin extend through the through hole of the plate 16. In yet another alternative, not shown, embodiment the attachment means 17 present a bayonet joint instead of interacting internal/external threads.

Preferably the stem 18 of the attachment means comprises at least a first channel branch 13′ of the channel 13 of the supporting structure 4, the first channel branch 13′ may for instance be constituted by a groove in the envelope surface of the stem 18 or by an internal hole in the stem 18, in order to guide the gas from the gas supply conduit 2 to the through hole 20 in the plate 16. In a not shown embodiment the part of the holder 5 that the stem 18 is in engagement with is provided with a groove in order to guide the gas past the stem 18 to the through hole 20 in the plate 16, at the same time as the stem 18 of the attachment means may be massive.

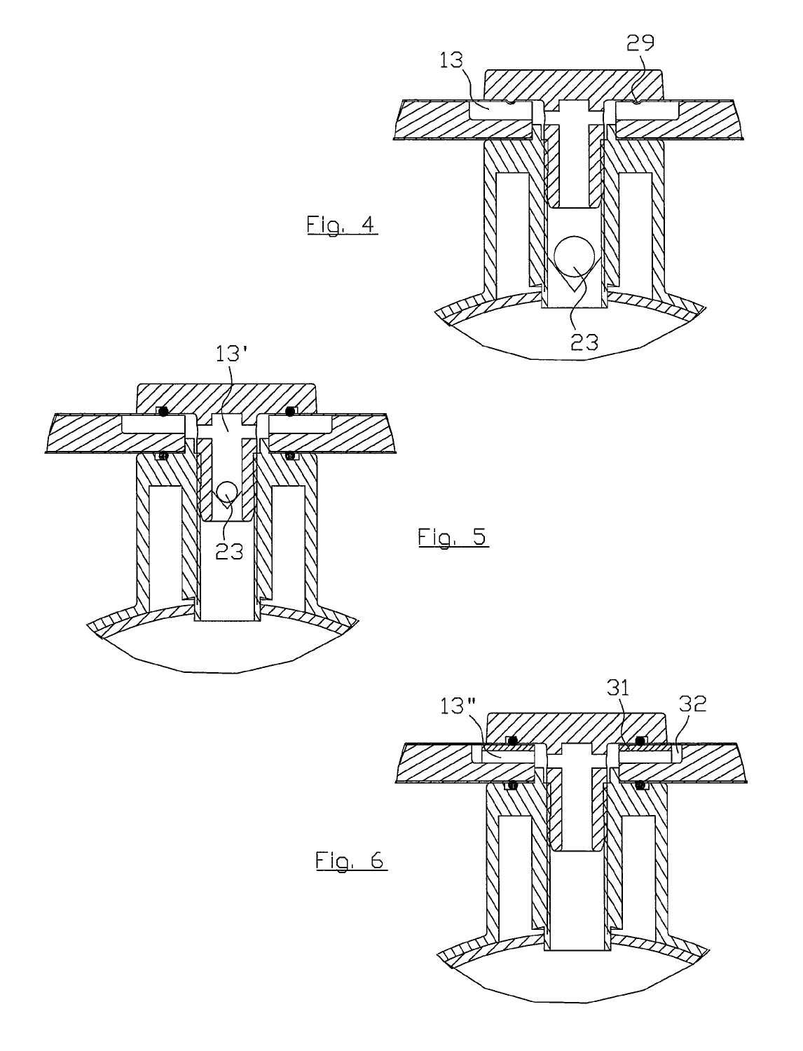

The plate 16 of the supporting structure present in the shown embodiments a first surface 21 that is turned towards the first membrane member 11 and a second surface 22 that is opposed the first surface 21, which second surface 22 is turned towards the second membrane member 12. When the diffusor 1 is not active at least the part of the first membrane member 11 that is perforated preferably abut the first surface 21 of the plate 16, in order to seal off the perforations such that the surrounding liquid does not enter into the inner chamber 10 of the membrane 3. Preferably the first surface 21 of the plate 16 is even in order to provide a good sealing against the first membrane member 11 when the diffusor 1 is not active. According to an alternative embodiment a non-return valve 23 (see FIG. 4) may be arranged in the holder 5. According to yet another alternative embodiment the non-return valve 23 (see FIG. 5) may be arranged in the channel 13 of the supporting structure 4, preferably in the first channel branch 13′ in the stem 18 of the attachment means. It shall be pointed out that the second surface 22 of the plate 16 may be provided with a number of recesses, in order to provide material and weight savings without jeopardizing the supporting function of the plate 16. The plate 16 may also be constituted by a sandwich structure, comprising a whole first surface 21 and a whole second surface 22 and an intermediate honeycomb structure or the like.

Thereto the plate 16, the head 19 of the attachment means, or the holder 15 may comprise a through hole (not shown) into which a pressure sensor may be inserted and measure the pressure existing in the diffusor 1 during operation. An elevated pressure indicates that the membrane 3 is clogged and need to be changed. In the case the pressure sensor hole is located in the head 19 of the attachment means or in the holder 5 is most be plugged of it is not used. In the case the pressure sensor hole is located in the plate 16 it is enough that the second membrane member 12 is whole and the pressure sensor hole is not used, and when the pressure sensor hole for the first time shall be used a hole is generated in the second membrane member 22 whereupon the pressure sensor is inserted through the hole and screwed into the pressure sensor hole whereupon the second membrane member 22 seal against the second surface of the plate 16.

In preferred embodiments of the inventive diffusor 1 the through hole 20 of the plate overlap a through hole 24 arranged in the first membrane member 11 and a through hole 25 arranged in the second membrane member 12. In mounted state the head 19 of the attachment means cover the through hole 24 of the first membrane member 11 and clamp the first membrane member 11 against the first surface 21 of the plate, at the same time as the stem 18 of the attachment means is connected to said head 19 and the holder 5, the second membrane member 12 being clamped between the second surface 22 of the plate and a seat 26 of the holder 5.

Preferably the diffusor 1 comprises a first O-ring 27 arranged between the head 19 of the attachment means and the first membrane member 11, and/or a second O-ring 28 arranged between the second membrane member 12 and the seat 26 of the holder. In an alternative embodiment (see FIG. 4) the head 19 of the attachment means comprises, instead of above mentioned O-rings or as a complement thereto, a circumferential ridge 29 that projects in the direction towards the first surface 21 of the plate, and it shall be pointed out that the seat 26 of the holder may present a projecting circumferential ridge (not shown). In yet another alternative embodiment or supplementary embodiment the first membrane member 11 may comprise an embedded or fixedly connected reinforcement (not shown) that extend around and enclose the through hole 24 of the first membrane member 11, in order to prevent the through hole 24 of the first membrane member 11 to be enlarged due to large tensile force in the first membrane member 11. Correspondingly the second membrane member 12 may comprise an embedded or fixedly connected reinforcement (not shown) extending around and enclosing the through hole 25 of the second membrane member 12.

Preferably the seat 26 of the holder 5 presents a collar 30, which is inserted into the through hole 20 of the plate 16 when the diffusor is in the mounted state, the main purpose of the collar 30 is to position the plate 16 onto the holder 5 before the attachment means 17 is applied.

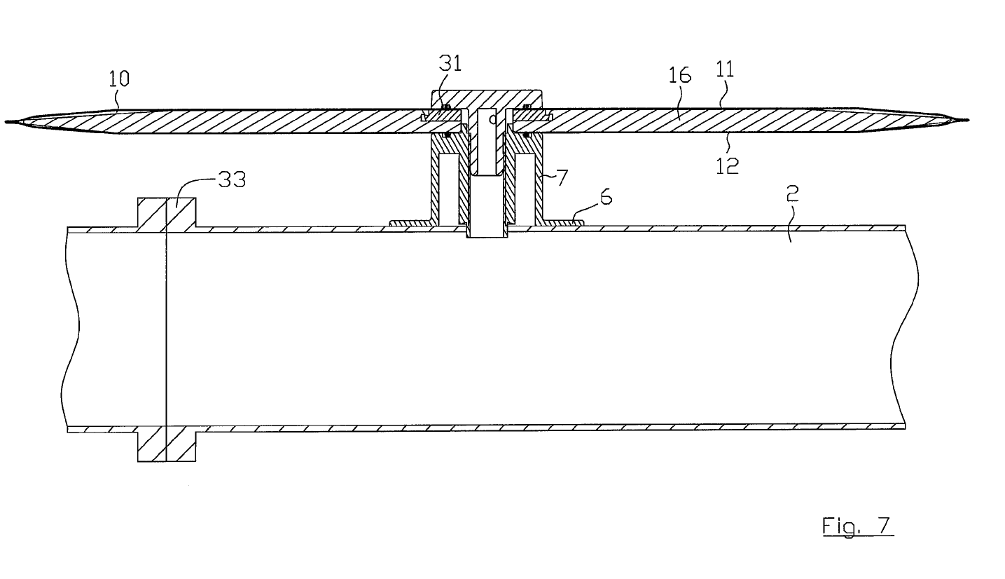

Reference is now mainly made to FIGS. 6 and 7, in which the supporting structure 4 comprises a distribution puck 31 arranged in a seat 32 of the plate 16 of the supporting structure, at least a second channel branch 13″ of the channel 13 of the supporting structure being arranged in said distribution puck 31. As is apparent from FIG. 7 said distribution puck 31 is preferably connected to the plate 16 by means of snap fit. The advantage of using a distribution puck 31 that is disengageably or fixedly connected to the seat 32 of the plate, is that an unbroken circumferential abutment between the head 19 of the attachment means and the first membrane member 11 and between the first membrane member 11 and the first surface 21 of the plate, respectively, is provided. The distribution puck 31 has one or several radially extending grooves constituting said second channel branch 13″. In the embodiments lacking a distribution puck one or several grooves are arranged in the first surface 21 of the plate in order to provide fluid communication between the through hole 20 of the plate 16 and the inner chamber 10 of the membrane 3. It shall also be pointed out that the plate 16 also may comprise channel holes (not shown) extending from the through hole 20 of the plate to the first surface 21 of the plate. In an alternative embodiment an O-ring or the like may be arranged between the distribution puck 31 and the seat 32, such that the upper surface of the distribution puck 31 and the lower surface of the head 19 of the attachment means automatically shall take a mutually parallel relationship due to the fact that the distribution puck may be slightly inclined in relation to the plate 16.

The membrane 13 of the diffusor may present any feasible basic shape, in the shown embodiments the membrane 3 is rectangular. Other feasible basic shapes are round, oval, quadratic, etc. Preferably the plate 16 of the diffusor presents a basic shape corresponding to the basic shape of the membrane 3, and it is yet more preferred that the plate 16 is slightly smaller than the membrane 3 seen in the main extension plane of the diffuser unit, when the diffusor is not activated. When the diffusor 1 is activated and the membrane 3 is inflated at least the first membrane member 11 will lift from the first surface 21 of the plate 16 and the membrane 3 will abut against the edge of the plate 16 in the area of the circumferential peripheral edge of the membrane, the first membrane member 11 of the membrane 3 being prevented from lifting uncontrollably from the plate 16. The plate 16 also has the function of preventing the radially outer parts of the membrane 3 from floating upwards when the membrane 3 is inflated. Thus, the shape of the plate 16 defines greatly the shape the membrane 3 will take when the diffusor is activated.

It shall be pointed out that, especially in the cases the membrane 3 of the diffusor is relatively large, the first membrane member 11 and the second membrane member 12 may be connected to each other at other places than close to the circumferential peripheral edge, in order to provide a sufficiently large inflation of the membrane 3 during operation. More precisely the first membrane member 11 and the second membrane member 12 may be connected to each other at one or more discrete points/lines/fields located at a distance from the circumferential peripheral edge or at lines/fields extending inwardly from and at an angle to the circumferential peripheral edge. Thereto the plate 16 of the diffusor must in this case present holes or recesses at the locations where the first membrane members 11 and the second membrane members 12 are connected.

In a preferred embodiment the plate 16 of the supporting structure is turnable in relation to the seat 25 of the holder 5, preferably the plate 16 may be positioned in predetermined positions in relation to the seat 26. For instance, in the case the diffusor is rectangular, the long axis of the diffusor 1 may be arranged in parallel with or perpendicular to the gas supply conduit the diffusor 1 is connected to, however, other orientations are feasible. The positioning in predetermined positions may for instance be effected by means of, not shown, interacting projections and recesses in the seat 26 of the holder 5 and in the second surface 22 of the plate 16. The advantage coming from the diffusor 1 being able to take different positions, is above all that the position of several diffusors may be adapted to each other and to the basin such that an as large bottom coverage as possible is obtained. It shall also be pointed out that the diffusors may have mutually different shape in one and the same basin.

As is apparent from FIG. 7 the present invention entail that the membrane 3 may shoot over a connection 33 between different segments of the gas supply conduit 2, which entail that a larger bottom coverage may be obtained. At need the membrane 3 may be turned in order to provide access to said connection 33.

In a not shown embodiment the diffusor 1 comprises a shim, washer or the like, arranged between the head 19 of the attachment means 17 and the first membrane member 11, such that the first membrane member 11 does not crease/distort when the attachment means 17 is tightened, but gliding shall take place between the head 19 of the attachment means and the shim. The shim may be constituted by a separate element or be rotateably connected to the attachment means 17.

It shall be realized that in the embodiments in which the diffusor comprises a first O-ring 27 arranged between the head 19 of the attachment means and the first membrane member 11 the first O-ring 27 shall be arranged between the first membrane member 11 and the shim. It shall furthermore be realized that in the embodiments in which the diffusor comprises a circumferential ridge 29 projecting from the head 19 of the attachment means in the direction towards the first membrane member 11 the circumferential ridge 29 shall instead be connected to and projecting from the shim.

Is shall also be pointed out that the diffusor correspondingly also may comprise a corresponding shim arranged between the second membrane member 12 and the seat 26 of the holder.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

It shall also be pointed out that all information about/concerning terms such as upper, lower, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design.

It shall also be pointed out that even thus it is not explicitly stated that features from a specific embodiment may be combined with features from another embodiment, the combination shall be considered obvious, if the combination is possible.

1. A diffusor for diffusing a gas into a liquid, comprising a membrane, a supporting structure supporting said membrane and a holder arranged to connect said supporting structure to a gas supply conduit, at least a part of the membrane being perforated, the membrane defining an inner chamber, and at least a part of the supporting structure is arranged in the inner chamber of the membrane, the supporting structure comprising at least one channel extending from an inlet opening that is in, direct or indirect, fluid communication with the gas supply conduit to an outlet opening that is in fluid communication with said inner chamber of said membrane, the supporting structure comprising a plate, which is arranged in the inner chamber of the membrane and which comprises a through hole, and an attachment means, which is arranged in said through hole and which is connected to the holder.

2. The diffusor according to claim 1, wherein said membrane is made of an elastomer.

3. The diffusor according to claim 1, wherein said membrane is made of a plastic.

4. The diffusor according to claim 1, wherein the membrane comprises a first membrane member and a second membrane member, which are connected to each other in an area of a circumferential peripheral edge.

5. The diffusor according to claim 4, wherein the first membrane member and the second membrane member are connected to each other by welding or vulcanization.

6. The diffusor according to claim 4, wherein at least a part of the first membrane member is perforated, and the second membrane member is imperforated.

7. The diffusor according to claim 4, wherein at least a part of the first membrane member is perforated, and the second membrane member comprises a number of drainage holes.

8. The diffusor according to claim 1, wherein at least a part of the membrane is reinforced by metal wire, synthetic fibre or glass fibre.

9. The diffusor according to claim 4, wherein the supporting structure comprises a plate, which is arranged in the inner chamber of the membrane, and an attachment means, which is arranged to secure the plate and the membrane to the holder.

10. The diffusor according to claim 9, wherein the outlet opening of a supporting structure mouth in a first surface of the plate, and in that the first surface of the plate is turned towards the first membrane member of the membrane.

11. The diffusor according to claim 9, wherein the plate of the supporting structure comprises the through hole, which is arranged in a central area of the plate of the supporting structure.

12. The diffuser according to claim 11, wherein the through hole of the plate overlaps a through hole arranged in the first membrane member and a through hole arranged in the second membrane member, and the attachment means of the supporting structure comprises a head and a stem, wherein the head of the attachment means covers the through hole of the first membrane member and clamps the first membrane member against the first surface of the plate, and wherein the stem of the attachment means is connected to said head and the holder, wherein the second membrane member is clamped between a second surface of the plate, which second surface is opposed to the first surface, and a seat of said holder.

13. The diffusor according to claim 12, wherein the head of the attachment means is fixedly connected to the stem, which is disengageably connected to the holder.

14. The diffusor according to claim 12, wherein the head of the attachment means comprises a circumferential ridge projecting in a direction from the first surface of the plate.

15. The diffusor according to claim 12, wherein the diffusor comprises a first O-ring arranged between the head of the attachment means and the first membrane member, and a second O-ring arranged between the second membrane member and the seat of the holder.

16. The diffusor according to claim 12, wherein the stem of the attachment means comprises at least one first channel branch of the channel of the supporting structure.

17. The diffusor according to claim 16, wherein the stem of the attachment means comprises a nonreturn valve arranged in said first channel branch which non-return valve prevents a flow in a direction from the outlet opening of the channel of the supporting structure to the gas supply conduit.

18. The diffusor according to claim 12, wherein the plate of the supporting structure is turnable in relation to the seat of the holder.

19. The diffusor according to claim 18, wherein the plate of the supporting structure is arranged to be positioned in predetermined positions in relation to the seat of the holder.

20. The diffusor according to claim 17, wherein the supporting structure comprises a distribution puck arranged in a seat in the plate of the supporting structure, at least a second channel branch of the channel of the supporting structure being arranged in said distribution puck.

21. The diffusor according to claim 12, wherein the diffusor comprises a first shim arranged between the head of the attachment means and the first membrane member.

22. A diffusor unit for connection to a holder connected to a gas supply conduit, comprising a membrane, a supporting structure supporting said membrane, at least a part of the membrane being perforated and the supporting structure being configured to be connected to said gas supply conduit via said holder, the membrane defining an inner chamber, and at least a part of the supporting structure is arranged in the inner chamber of the membrane, the supporting structure comprising at least one channel extending from an inlet opening that is arranged to be in, direct or indirect, fluid communication with the gas supply conduit to an outlet opening that is in fluid communication with said inner chamber of said membrane, the supporting structure comprising a plate, which is arranged in the inner chamber of the membrane and which comprises a through hole, and an attachment means, which is arranged in said through hole.
